(19) United States
(12) Patent Application Publication
(10) Pub. No.: US 2013/0276715 A1
(43) Pub. Date: Oct. 24, 2013

(54) LITTER BOX GUARD

(71) Applicant: Vitila Brands LLC, Woodside, NY (US)

(72) Inventor: Sergey Zirkiyev, Woodside, NY (US)

(21) Appl. No.: 13/683,595

(22) Filed: Nov. 21, 2012

Related U.S. Application Data
(60) Provisional application No. 61/563,459, filed on Nov. 23, 2011.

(51) Int. Cl. A01K 1/01

(52) U.S. Cl. CPC A01K 1/0114
USPC 119/166; 119/165

(57) ABSTRACT

A litter box includes a bottom portion configured to hold an amount of sand, gravel or kitty litter, a cover element configured to cover the bottom portion; and an animal opening formed in at least one of the bottom portion and the cover element and configured and sized to allow a small animal to enter the litter box.

### CROSS-REFERENCE TO RELATED APPLICATIONS

The present application claims benefit of and priority to U.S. Provisional Patent Application Ser. No. 61/563,459 entitled LITTER BOX GUARD filed Nov. 23, 2011, the entire content of which is hereby incorporated by reference herein.

### BACKGROUND

1. Field of the Disclosure

The present disclosure relates generally to pet care, and more particularly, to a litter box and a litter box guard.

2. Related Art

Most indoor pets, particularly cats, use a litter box. Litter boxes hold sand, cat litter or other suitable material and a cat uses the litter box to relieve itself, and then buries the waste in the sand, cat litter or other suitable material. Other pet animals may be also trained to use litter boxes, such as rabbits, ferrets and guinea pigs.

After one pet uses a litter box another pet, a dog, for example, may go into the litter box and eat the fecal remains left behind. This is known as dog coprophagia, and dogs ingest cat feces deliberately and often habitually.

Pet owners are often concerned that dog coprophagia is indicative of abnormal behavior or some physical ailment. Such behavior is, however, not uncommon and does not necessarily indicate that the dog has some physical ailment. Nevertheless, dog coprophagia is particularly undesirable, and a source of great frustration for many pet owners.

Current and known litter boxes do not function well to prevent dog coprophagia. Dogs can too easily access the remains and ingest them. Moreover, litter boxes present other shortcomings. For example, litter boxes often have pungent smells. Also, cats often spread cat litter outside and around a litter box while burying their waste, which causes a mess. Moreover, pets that use litter boxes often get litter or sand stuck to their paws or in-between their pads, which eventually falls off somewhere outside the litter box.

Accordingly, it would be desirable to provide a litter box assembly that avoids these and other problems.

### SUMMARY

It is an object of the present disclosure to provide a litter box and a litter box accessory that prevents access to larger animals.

A litter box assembly in accordance with an embodiment of the present disclosure includes a bottom portion configured to hold an amount of sand, gravel or kitty litter, a cover element configured to cover the bottom portion and an animal opening formed in at least one of the bottom portion and the cover element and configured and sized to allow a small animal to enter the litter box.

A litter box accessory for use with a litter box including a box element including sand, gravel or kitty litter in accordance with an embodiment of the present disclosure includes a cover portion configured and sized to cover the box element of the litter box and at least one fastener configured to attach the cover portion to the box element. The cover portion includes an animal opening formed in a first end of the cover element and configured and sized to allow a small animal to pass through it into the box element.

Other features and advantages of the present invention will become apparent from the following description of the invention which refers to the accompanying drawings.

### BRIEF DESCRIPTION OF THE DRAWING

For the purpose of illustrating the invention, there is shown in the drawing several forms which are presently preferred, it being understood, however, that the invention is not limited to the precise arrangements and instrumentalities shown. The features and advantages of the present invention will become apparent from the following description of the invention that refers to the accompanying drawing, in which:

FIG. 1 is a side view of a litter box structure in accordance with an embodiment of the present disclosure.

FIG. 2A is an exploded view of a litter box structure in accordance with an alternative embodiment of the present disclosure.

FIG. 2B is a top elevated view of the litter box structure illustrated in FIG. 2A.

FIG. 2C is a left side view of the litter box structure illustrated in FIG. 2A.

FIG. 2D is a front view of the litter box structure illustrated in FIG. 2A.

FIG. 2E is a right side view of the litter box structure illustrated in FIG. 2A.

FIG. 2F illustrates a perspective view of the litter box structure of FIG. 2A.

FIG. 2G illustrates a top view thereof and includes exemplary dimensions.

FIG. 2H illustrates a side view of the litter box structure of FIG. 2A showing exemplary dimensions.

FIG. 2I illustrates a rear view of the litter box structure of FIG. 2A including exemplary dimensions.

FIG. 2J illustrates an opposite side view of the litter box structure of FIG. 2A including exemplary dimensions.

FIG. 3 is a cross sectional view of a litter box structure in accordance with another embodiment of the present disclosure.

FIG. 3A illustrates a side view of the litter box structure of FIG. 3

FIG. 3B an opposite side view of the litter box structure of FIG. 3.

FIG. 3C illustrates a front view of the litter box structure of FIG. 3

FIG. 3D illustrates a rear view of the litter box structure of FIG. 3.

FIG. 3E illustrates a top view of the litter box structure of FIG. 3.

### DETAILED DESCRIPTION OF THE EMBODIMENTS

In one or more embodiments, a litter box structure is provided that is shaped and configured to prevent animals, such as dogs, from reaching into the litter box, and to prevent dog coprophagia. In one or more other embodiments, a litter box accessory is provided that is coupled to an existing litter box to provide the litter box structure.

The litter box structure in accordance with an embodiment may be configured with at least one entrance opening that is sized large enough for a cat or other small animal to go into the litter box, while being sized too small for a dog to enter. By sizing the at least one entrance to be suitable only for cats or other small animals, larger animals such as dogs, or even small children, are prevented from entering the litter box structure and ingesting or otherwise disrupting waste remains. In one or more embodiments, the size of the at least one entrance opening may be configured to be adjustable and suitable for one or more particularly sized animals. In operation, a user may adjust the size of the entrance area to enable only a cat or other small animal to enter and exit the litter box structure. This may be accomplished with one or more folding doors, a shade or other suitable structure.

In an embodiment, a rim that may be configured at 2-3 inches wide runs around the entrance, such that a cat enters the litter box structure by going under or over the rim, while precluding a dog or child from entering.

Access to the litter box structure is restricted to a single entrance/exit point for a particularly sized animal, and prevents dog coprophagia.

In one or more embodiments, the litter box structure includes a bottom component that holds sand, cat litter or other suitable material for a cat to use to relieve itself. In one or more embodiments, the bottom component may be box-shaped or box-like shaped. Alternative shapes are also supported, including round shapes, oval shapes and other geometric shapes. The bottom component may be configured to provide a sub-portion or compartment for holding the sand, cat litter or other suitable material. For example, the bottom component may be provided with a raised curved portion at one end. The portion below the raised curved portion defines a compartment area in which the sand, litter or other suitable material is stored. The bottom component may be configured with a compartment area that is defined by a curvature provided at one end of the box-liked bottom component and that is located below the location of the entrance area. In other embodiments, the compartment may be defined by angled lines, a slanted straight line, one or more internal walls, or other suitable design.

In one or more embodiments, a cover portion is included with the litter box structure and coupled to the bottom component. The cover portion may be secured to the bottom component in one or more ways, such as via one or more latches, clips, snaps or other suitable fastener(s). Alternatively or in addition, the cover portion may be secured to the bottom component via one or more hinge elements, which enable the cover portion to pivot at one or more sides of the bottom component. Moreover, the cover portion may be configured to include the at least one entrance opening through which the cat or other animal enters and exits the litter box structure.

In one or more embodiments, an exit platform is coupled to and provided within the lower component that the cat or other small animal may step on when entering or exiting the litter box. The exit platform may be positioned below the entrance opening that is provided with the cover portion and useful as a walkway or ledge. In one or more embodiments, the exit platform is configured with a mesh-like material that is suitable to free any sand, cat litter or other material that may be stuck to the animal's paws or otherwise wedged between the pads. In at least one embodiment, the exit platform includes a slanted portion that bends downward and that causes any sand, cat litter or other suitable material that is freed from the cat's or other animal's paws to fall back into the box as the animals exits the litter box structure. Alternative designs are also supported, such as a straight platform that is angled downward into the bottom component. Alternatively, the exit platform may include one or more steps.

Moreover, the exit platform may also function as a physical barrier to the sand or cat litter and preclude a dog or child from accessing the sand or cat litter, even if the dog's or child's head enters the at least one entrance opening.

In addition to the at least one entrance opening, the cover portion may also include a door or other accessibility element that is positioned in an opposite or adjacent side of the cover portion. The door or other accessibility element is configured to provide easy access to the sand, cat litter or other suitable material that is stored in the lower component for easy access, for example, for cleaning and litter removal.

In one embodiment, the cover portion may also include a freshener compartment portion, for example, for holding air freshening material, such as air freshening powder or liquid. The freshener compartment portion may be located at the top of the cover portion, or other area, such as one of the vertical sides. Moreover, one or more handle portions may be attached to the top or side surface of the cover portion to enable the litter box structure to be carried easily.

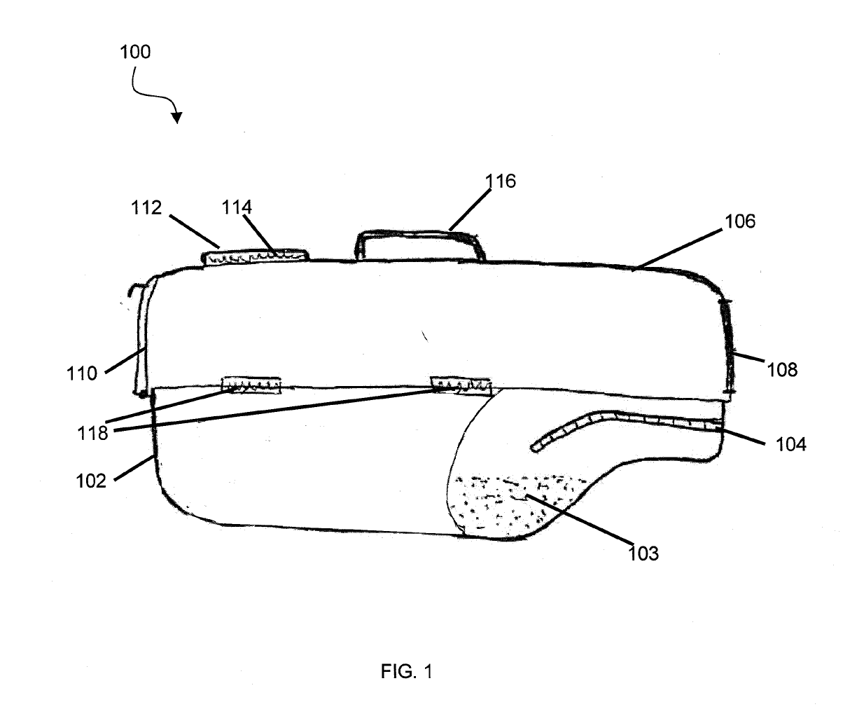

FIG. 1 illustrates a side view of an exemplary litter box structure 100 in accordance with an embodiment of the present disclosure. As shown in FIG. 1, a bottom component 102 is shaped and configured with a curvature at one end. In the example shown in FIG. 1, the curvature of bottom component 102 defines a compartment area 103 within the lower portion of bottom component 102. The compartment area 103 is configured to hold sand, cat litter or other suitable material for an animal to use to relieve itself. While the present application utilizes the terms sand, gravel and kitty litter, any suitable material may be used. Although the compartment area 103 is illustrated in FIG. 1 as being defined by a curvature, other shapes and configurations may be used. For example, the compartment area 103 may be shaped by one or more angled lines within a portion of bottom component 102. A portion of the bottom component 102 is cut away in FIG. 1 to illustrate the compartment area 103 and the platform 104 more clearly.

An exit platform 104 is preferably provided within the bottom component 102 and is configured to allow sand, litter and/or other suitable material to fall back into compartment area 103 as a cat or other animal exits litter box structure 100. As noted above, the exit platform 104 may include or otherwise be configured of a suitable mesh-like material to improve the ability for sand, cat litter or other suitable material to fall from the animal's feet. The exit platform 104 is illustrated with a curved portion at one end that slants downward toward compartment area 103. As noted above, other configurations are envisioned herein, including a slanted straight platform or a platform having one or more angled lines.

As shown in FIG. 1, cover portion 106 is shaped and configured to fit over the entire upper peripheral surface area of bottom component 102, thereby providing a complete cover to bottom component 102. An entrance opening 108 may be provided for a cat or other small animal to enter and exit litter box structure 100. As noted above, entrance opening 108 is adjustable to be sized to accommodate a particularly sized animal. As noted above, a folding door or adjustable shade may be provided in the opening 108 to adjust the size thereof. Further, and as shown in FIG. 1, access door 110 is provided on another side of cover portion 106, and opens and closes to allow for the addition and removal of sand, cat litter or other suitable material, as well as for the cleaning of waste. In the example shown in FIG. 1, access door 110 is located on a side that is opposite of entrance opening 108, although other suitable locations are supported. The access door 110 may be secured by a user to prevent any animal from accessing the bottom compartment via the door.

An air freshener compartment 112 may be provided on or in the upper surface of the cover portion 106. The air freshener compartment 112 is configured to store air freshening material, such as powder or liquid, to keep a room where the litter box structure 100 is located smelling fresh. In the embodiment shown in FIG. 1, the air freshener compartment 112 includes a sponge 114 that absorbs liquid air freshener and holds the liquid air freshener for a period of time. As noted above, other air freshening materials may be used.

Moreover, the litter box structure 100 is configured with a handle portion 116 included in the cover portion 106 and preferably fixed to the upper surface area thereof. The handle portion 116 is configured for easy lifting and carrying of the litter box structure 100. The cover portion 106 preferably couples to the lower box-like bottom component by lock latches 118, alternatively or in addition, hinges can be included to allow the cover portion 106 to be movable relative to the bottom component 102 from an open position in which the bottom portion is exposed and a closed positioned wherein the cover portion covers the bottom portion. Any suitable fastening mechanism may be used in the lock latches 118.

Thus, in connection with the teachings herein, a convenient and efficient litter box structure 100 is provided that prevents animal waste material from being consumed or scattered, for example, by dogs and/or small children. In accordance with the teachings herein, at least one animal entrance opening 108 is provided in litter box structure 100 and sized to prevent dogs, other animals and/or small children from getting into compartment area 103 that is included in bottom component 102. Further, cover portion 106 keeps odors inside the litter box structure, while air freshener compartment 112 contains air freshener material to keep a room smelling fresh and clean. Exit platform 104 is used for the cat or other animal to exit and enter litter box structure 100, and is shaped and configured to allow sand, cat litter or other suitable material to fall back into compartment area 103 of bottom component 102 during exiting. This precludes sand, cat litter or other suitable material from being dispersed throughout the room.

In an embodiment, the cover portion 106 may be configured as an accessory for attachment to a conventional litter box. That is, the cover portion 106 may be used to cover a conventional litter box to prevent access by larger animals. In this embodiment, the lock latches 118 are configured for attachment to a conventional litter box in any desired manner, including but not limited screw fasteners, clamps, etc. Otherwise, the cover portion 106 is configured and operable in much the same manner as described above.

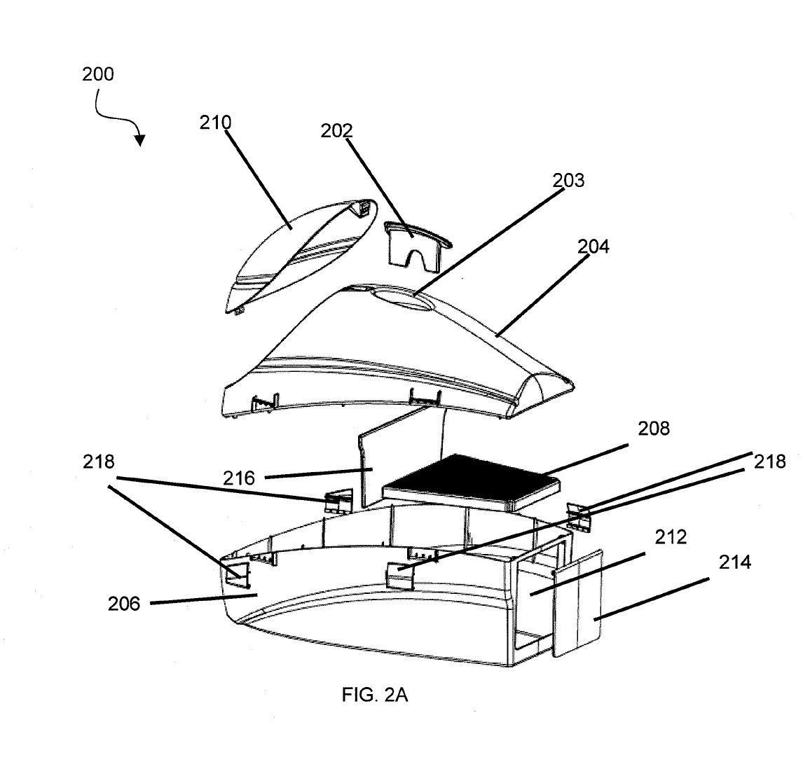

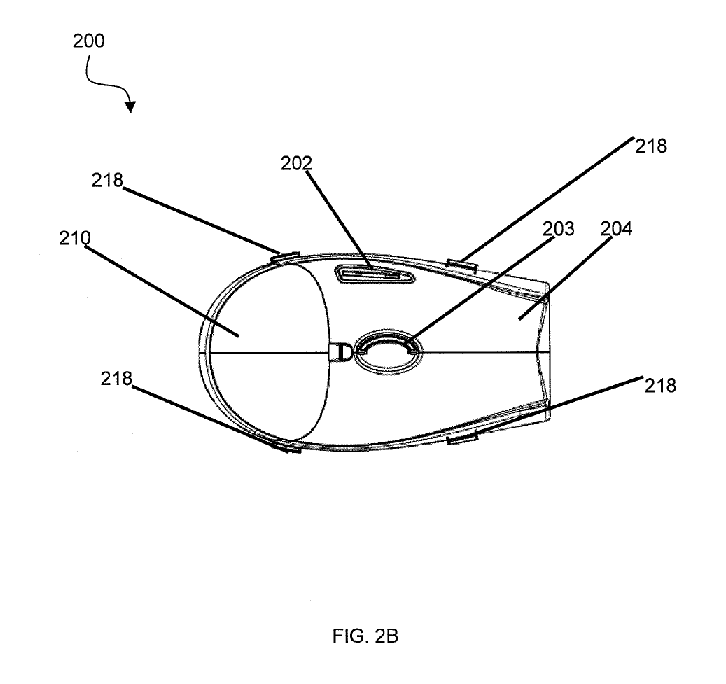

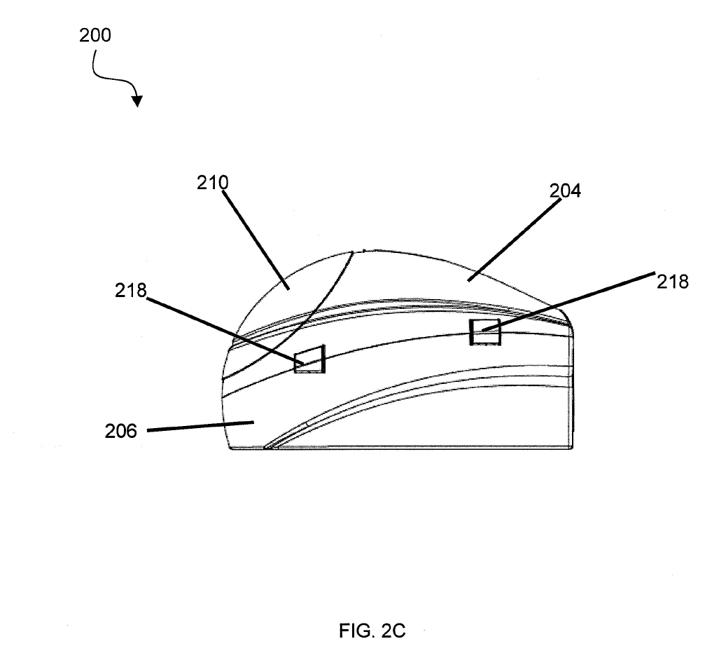

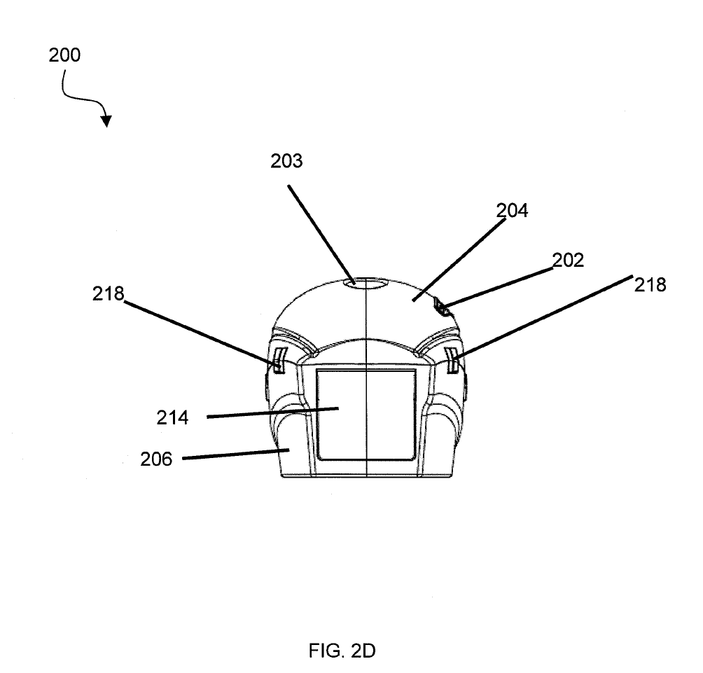

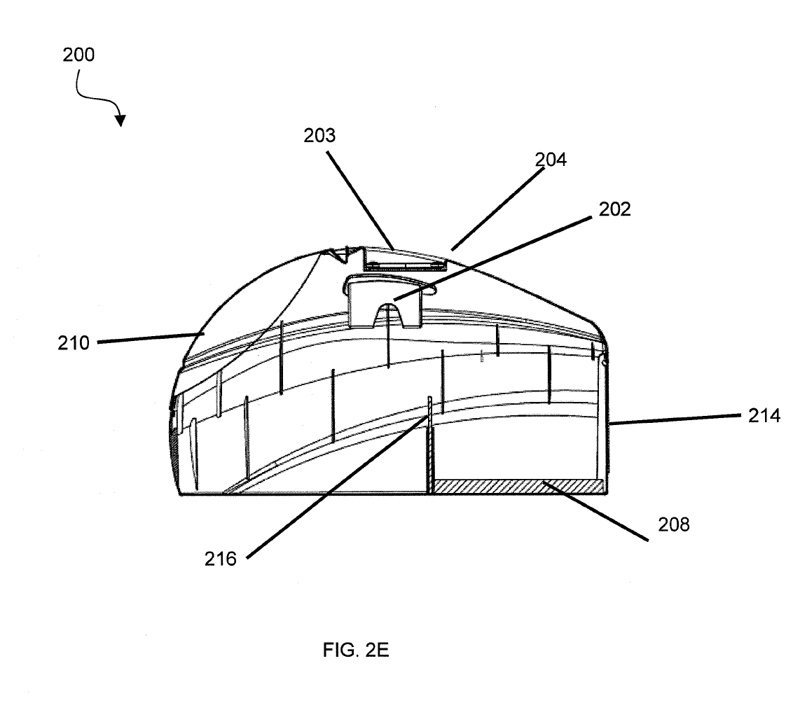

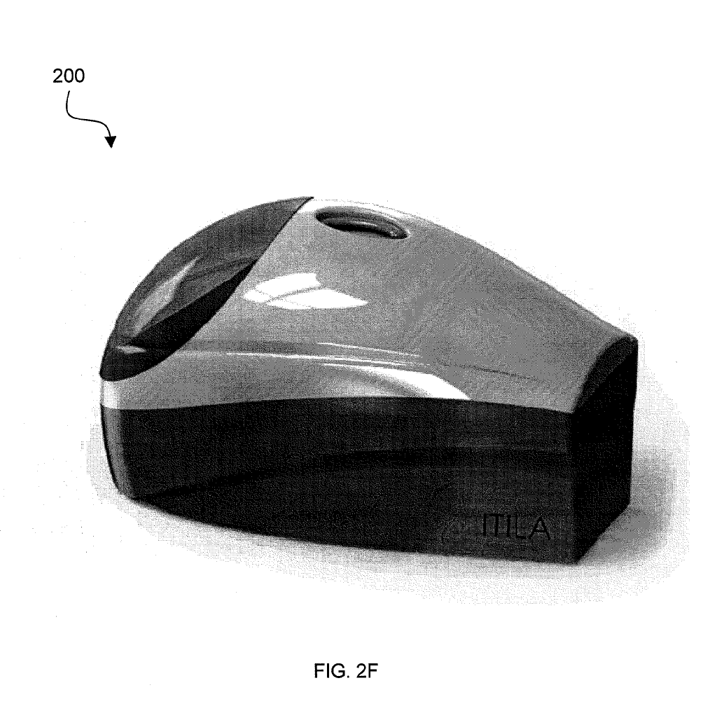

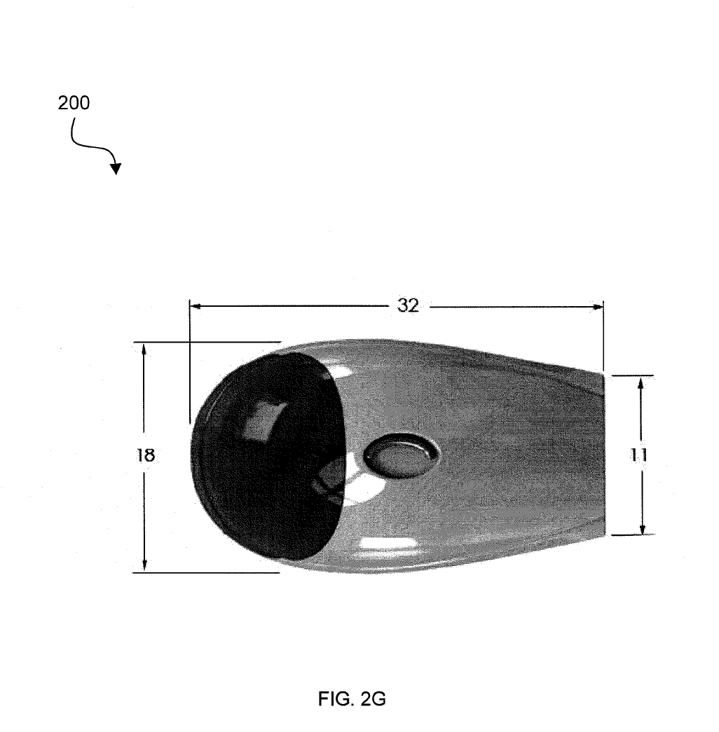

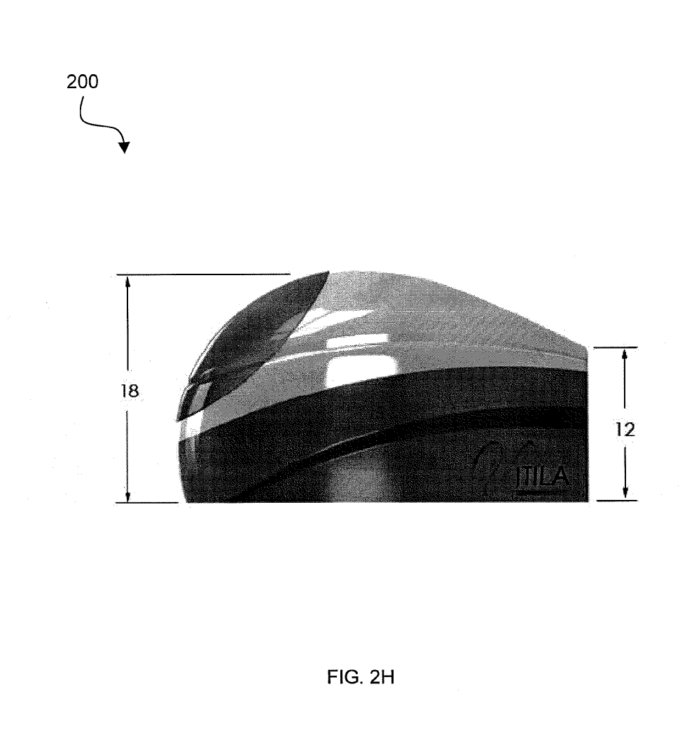

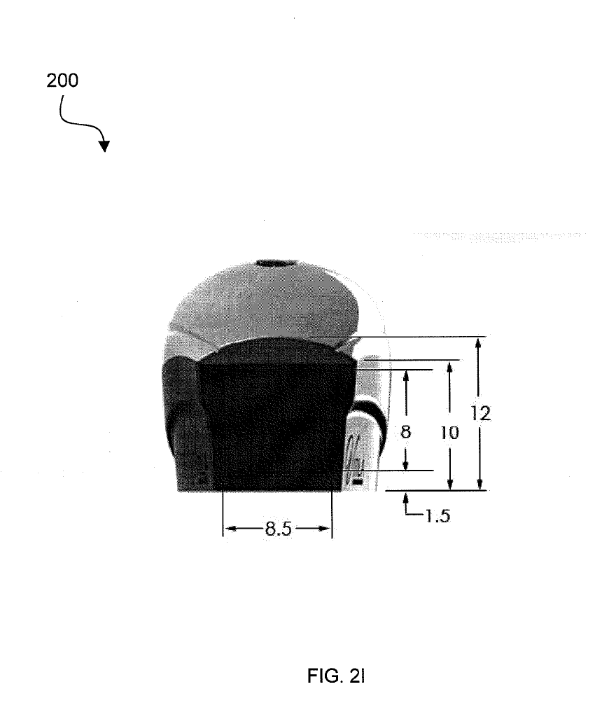

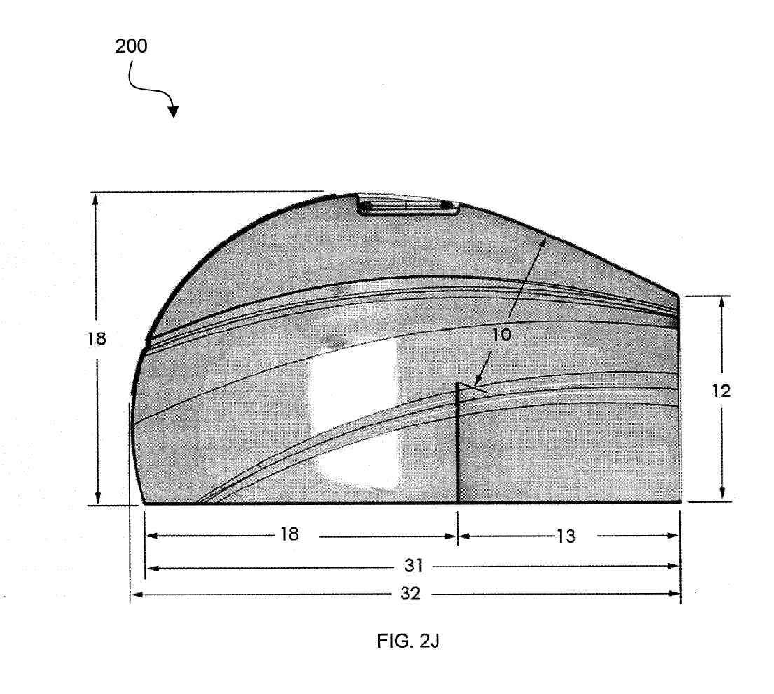

FIG. 2A is an exploded view of a litter box structure 200 in accordance with an alternative embodiment of the present disclosure. In the embodiment shown in FIG. 2A, a filter 202 is provided. The filter 202 may include a sponge, charcoal or other suitable material to absorb odor. The filter 202 may or may not include an air freshener or other deodorant material. The litter box structure 200 also includes a handle area 203, which is configured for convenient carrying of the litter box structure 200.

As shown in FIG. 2A, a cover portion 204 is shaped and configured to fit over the entire upper peripheral surface area of the bottom portion 206, thereby providing a cover to the bottom portion 206. The sand or kitty litter is preferably provided in the bottom portion 206. Also shown in FIG. 2A, platform 208 may include or otherwise be configured of a suitable mesh-like material to improve the ability for sand, cat litter or other suitable material to fall from the animal's feet. The platform 208 may be configured with other suitable material, such as rubber or cloth, as well.

Further, and as shown in FIG. 2A, an access door 210 is provided on a side of the cover portion 204, and opens and closes to allow for the addition and removal of sand, cat litter or other suitable material, as well as for the cleaning of waste. In the example shown in FIG. 2A, access door 210 is located on a side that is opposite of entrance opening 212, although other suitable locations are may be used. Moreover, An animal entrance door 214, which may be configured as a swinging door. As illustrated in FIG. 2A, or other suitable door for a cat or other animal to enter/exit litter box structure 200 is provided as well. The door 214 may be operated by an animal without human user intervention.

A panel 216 is preferably provided within the litter box structure 200 and separates a portion of litter box structure 200 that holds or otherwise contains cat litter from the platform 208. Cats or other animals using litter box structure to relieve themselves preferably walk over panel 216 to reach the portion of litter box structure 200 containing cat litter. Dogs or other animals are discouraged or prevented from entering that portion of litter box structure 200 due to panel 216 obstructing access thereto.

Also shown in FIG. 2A, the cover portion 204 preferably couples to the lower box-like structure by lock latches 218. Moreover, hinges may be included to assist in securing cover portion 204 to bottom portion 206 and to allow the cover portion to move relative to the bottom portion, as desired. The latches 218 ensure a tight fit, which prevents urine, cat litter or other waste from exiting the litter box structure 200.

FIG. 2B is a top elevated view of litter box structure 200.

FIG. 2C is a left side view of litter box structure 200.

FIG. 2D is a rear view of litter box structure 200.

FIG. 2E is a right side view of litter box structure 200.

FIGS. 2F-2J illustrate additional views and examples of litter box structure 200. More specifically, FIG. 2F illustrates a perspective view of the litter box structure. FIG. 2G illustrates a top view thereof and includes dimensions of the litter box structure in inches. FIG. 2H illustrates a side view of the litter box structure 200 showing exemplary dimensions. FIG. 2I illustrates a rear view of the litter box structure including exemplary dimensions. FIG. 2J illustrates an opposite side view of the litter box structure including exemplary dimensions. The dimensions illustrated in FIGS. 2G-2J are exemplary only and the litter box structure 200 is not limited thereto.

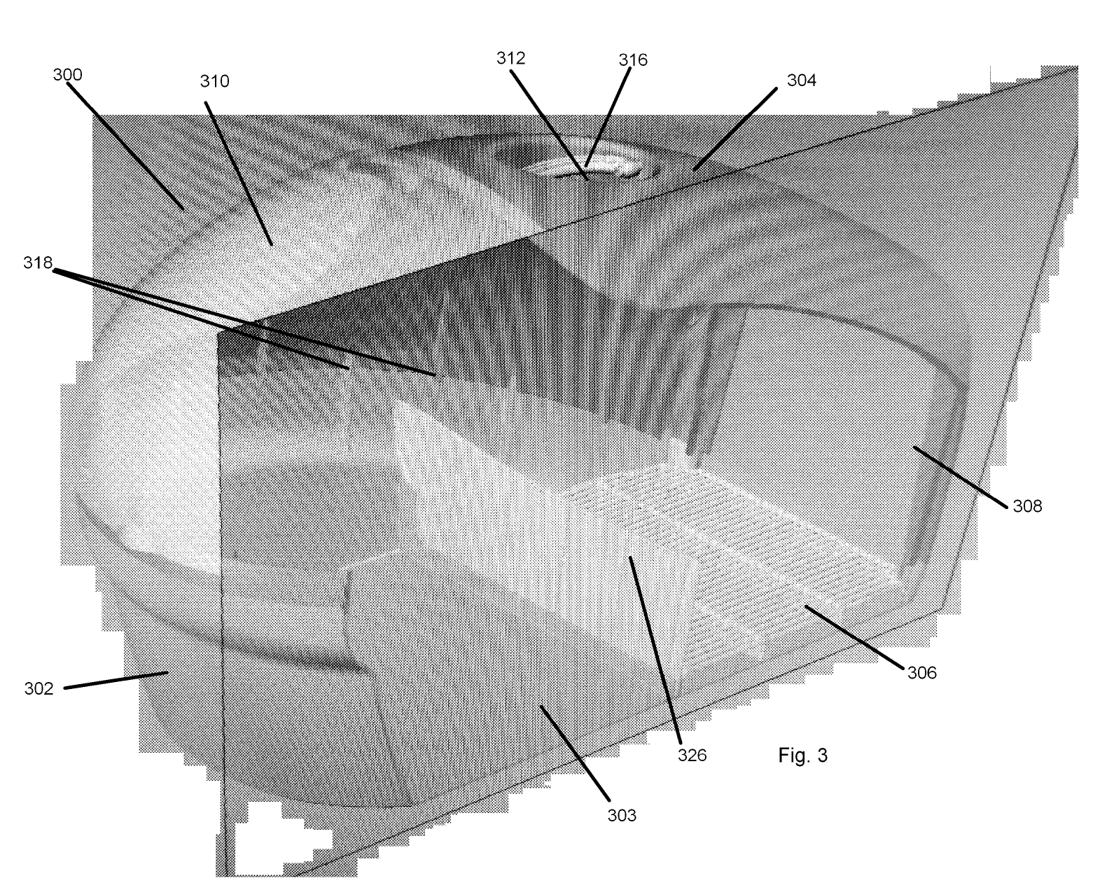

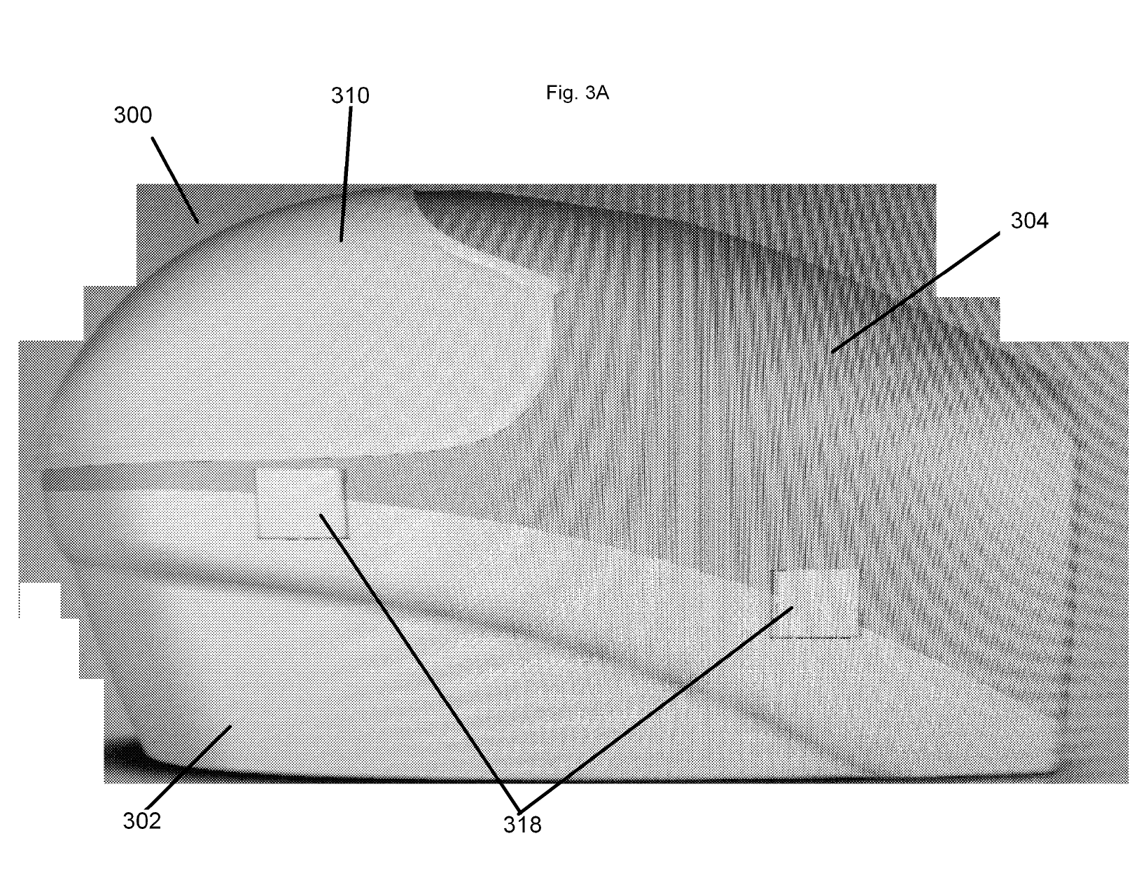

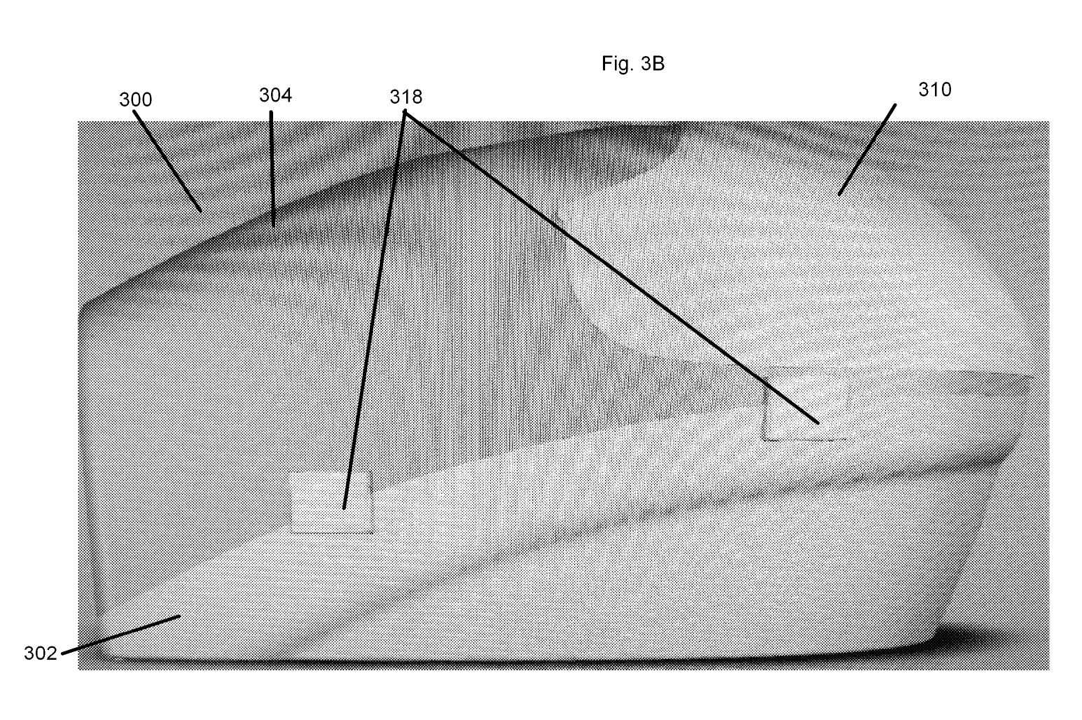

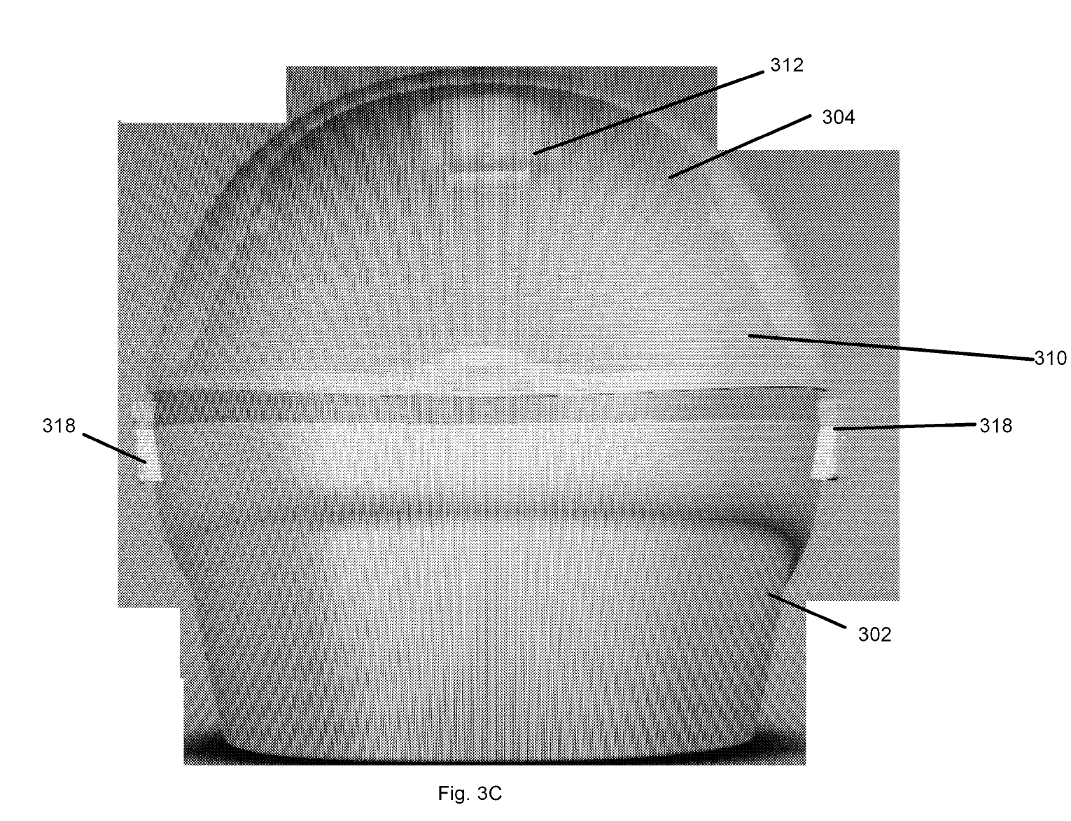

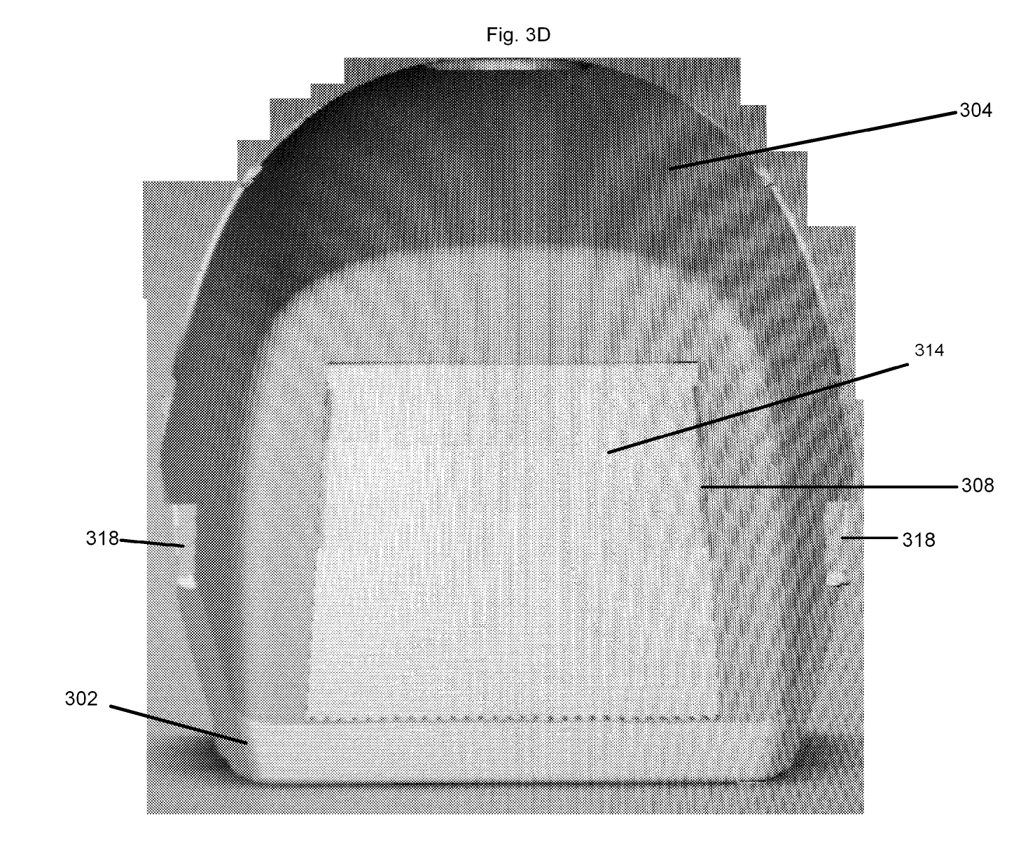

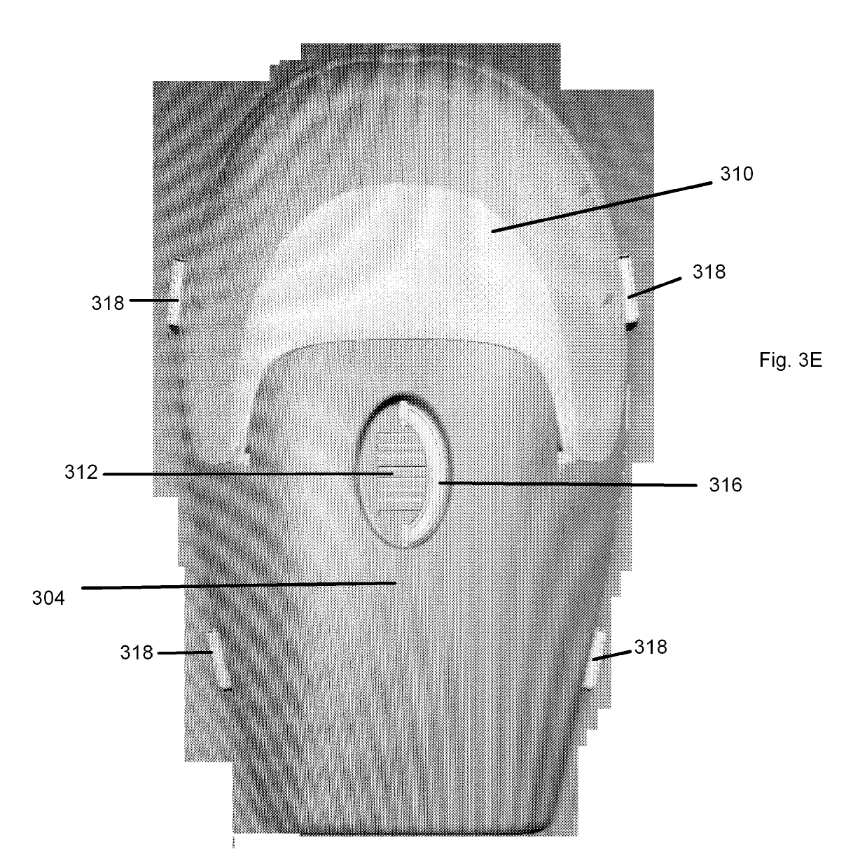

FIG. 3 illustrates a litter box structure 300 in accordance with a preferred embodiment of the present disclosure. The litter box structure 300 includes a bottom portion 302 which includes a container portion 303 in which the sand, gravel, kitty litter or other suitable material is provided. A cover portion 304 covers the entire bottom portion 302. An animal opening 308 is formed in one end of the cover portion 304. In an embodiment, the animal opening 308 may be covered by a swinging door 314, as shown in FIG. 3D, however, no door is necessary. Opposite the opening 308, an access door 310 is provided in the cover portion 304 to allow access to the container area 303. This access door 310 allows a user to easily access the container area 303 to access the sand, gravel, kitty litter or other suitable substance for changing or cleaning. The door 310 may be secured to prevent an animal from entering the litter box 300 via the door.

A platform 306 is preferably provided in the bottom portion 302 adjacent to the opening 308. The platform 308 includes openings to allow sand, gravel or kitty litter to fall from an animal's feet prior to exiting the litter box 300. A vertical panel 326 is preferably provided between the platform 306 and the container area 303. The panel 326 discourages larger animals from moving further into the litter box 300, while allowing cats and small animals to pass. A filter 312 is provided in a top portion of the cover portion 304 along with a handle 316. The lock latches 318 are provided to secure the cover portion 304 to the bottom portion 302. While the term “latches” is used, the lock latches 318 may include any suitable fastening mechanism and are not limited to latches.

FIG. 3A illustrates a side view of the litter box structure 300 while FIG. 3B illustrates an opposite side view. FIG. 3C illustrates a front view of the litter box while FIG. 3D illustrates a rear view. The accessory door 310 in FIG. 3C is partially transparent such that the filter 312 is visible. FIG. 3E illustrates a top view of the litter box 300.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A litter box comprising:
a bottom portion configured to hold an amount of sand, gravel or kitty litter;
a cover element configured to cover the bottom portion; and
an animal opening formed in at least one of the bottom portion and the cover element and configured and sized to allow a small animal to enter the litter box.

2. The litter box of claim 1, further comprising an adjustment device configured to adjust a size of the animal opening to accommodate a particular small animal.

3. The litter box of claim 1, further comprising a handle connected to a top portion of the cover element and configured to allow a user to lift the litter box.

4. The litter box of claim 1, further comprising a platform element, the platform element positioned in the bottom portion and adjacent to the animal opening.

5. The litter box of claim 4, wherein the platform element is configured to allow sand, gravel or kitty litter to pass through the platform element as an animal walks on the platform element.

6. The litter box of claim 8, further comprising a vertical panel position adjacent to the platform, opposite the animal opening and configured to interfere with passage of a large animal.

7. The litter box of claim 1, further comprising a deodorizing element mounted in the cover portion.

8. The litter box of claim 7, wherein the deodorizing element is configured to receive a liquid or powder deodorizing agent.

9. The litter box of claim 8, wherein the deodorizing element includes a sponge configured to absorb a predetermined amount of liquid deodorizing agent.

10. The litter box of claim 1, further comprising a filter compartment positioned in the cover portion and operable to filter odors from the litter box.

11. The litter box of claim 1, further comprising an access door positioned in the cover element at an end opposite the animal opening, the access door configured to provide access to a user to the sand, gravel or kitty litter in the bottom portion.

12. The litter box of claim 11, wherein the access door is secured in a closed position to prevent the small animal from accessing the sand, gravel or kitty litter through the access door.

13. The litter box of claim 1, further comprising at least one fastening mechanism configured to secure the cover portion to the bottom portion.

14. A litter box accessory for use with a litter box including a box element including sand, gravel or kitty litter, the litter box assembly comprising:
a cover portion configured and sized to cover the box element of the litter box; and
at least one fastener configured to attach the cover portion to the box element;
the cover portion including an animal opening formed in a first end of the cover element and configured and sized to allow a small animal to pass through it into the box element.

15. The litter box accessory of claim 14, wherein the cover portion further comprises an adjustment device configured to adjust a size of the animal opening to accommodate a particular small animal.

16. The litter box accessory of claim 14, wherein the cover element further comprises a deodorizing element.

17. The litter box accessory of claim 14, wherein the cover element further comprises a filter compartment positioned in the cover portion and operable to filter odors from the box element.

18. The litter box accessory of claim 14, wherein the cover element further comprises a handle positioned on a top surface thereof and configured to allow a user to carry the litter box accessory and the litter box.

19. The litter box accessory of claim 14, wherein the cover element further comprises an access door positioned opposite the animal opening and configured to allow access to the box element.

20. The litter box accessory of claim 19, wherein the access door is secured in a closed position to prevent the small animal from accessing the sand, gravel or kitty litter in the box element through the access door.
